(19) United States
(12) Patent Application Publication
(10) Pub. No.: US 2016/0066118 A1
(43) Pub. Date: Mar. 3, 2016

(54) AUDIO SIGNAL PROCESSING METHOD USING GENERATING VIRTUAL OBJECT

(71) Applicant: INTELLECTUAL DISCOVERY CO., LTD., Seoul (KR)

(72) Inventors: Hyun Oh OH, Seongnam-si (KR); Myungsuk SONG, Seoul (KR)

(73) Assignee: INTELLECTUAL DISCOVERY CO., LTD., Seoul (KR)

(21) Appl. No.: 14/784,349

(22) PCT Filed: Apr. 15, 2014
(86) PCT No.: PCT/KR2014/003250

§ 371 Date: Oct. 14, 2015

(30) Foreign Application Priority Data
Apr. 15, 2013 (KR) 10-2013-0040923
Apr. 15, 2013 (KR) 10-2013-0040931
Apr. 15, 2013 (KR) 10-2013-0040957
Apr. 15, 2013 (KR) 10-2013-0040960
Apr. 24, 2013 (KR) 10-2013-0045502

(51) Int. Cl. H04S 3/00; H04S 7/00

(52) U.S. Cl. CPC H04S 3/008; H04S 7/302; H04S 2400/11; H04S 2400/03

(57) ABSTRACT

The audio signal processing method according to one embodiment of the present invention comprises the steps of: when reproducing an audio signal that includes an object signal, receiving an audio bit-stream including object sound source information and an object audio signal; distinguishing between a first reproduction range object and a second reproduction range object on the basis of the object sound source information or reproduction range information; and rendering the first reproducing range object by a first method and rendering the second reproduction range object by a second method.

### TECHNICAL FIELD

The present invention generally relates to an audio signal processing method, and more particularly to a method for encoding and decoding an object audio signal and for rendering the signal in 3-dimensional space.

This application claims the benefit of Korean Patent Applications No. 10-2013-0040923, No. 10-2013-0040931, No. 10-2013-0040957, and No. 10-2013-0040960, filed Apr. 15, 2013, and No. 10-2013-0045502 filed Apr. 24, 2013, which are hereby incorporated by reference in their entirety into this application.

### BACKGROUND ART

Consumers' demands for a large screen display environment, such as a UHD TV are increasing. When such a high-resolution high-definition large screen is installed, it is desirable to provide vivid and fuller sound as befits the large-scale content. In the case of a UHD TV, a left-right viewing angle is expanded to a maximum of 100°, and a top-bottom viewing angle is also very wide. The top-bottom viewing angle in an HD TV environment is about 10°, whereas, when a UHD TV is installed at the same viewing distance, the viewing angle amounts to about 45°. To provide an environment that enables viewers to feel as if they are in the scene, an audio environment capable of locating sound sources in the wider range is required.

A multi-channel audio environment proposed by NHK adds a top layer and a bottom layer, and provides a total of 9 channels in the top layer. A total of 9 speakers are arranged in such a way that 3 speakers are arranged at the front, center, and back positions. In the middle layer, 5, 2, and 3 speakers are respectively arranged at the front, center, and back positions. In the bottom layer, 3 speakers are arranged at the front, and 2 LFE channels may be installed.

Generally, a specific sound source may be located in the 3-dimensional space by combining the outputs of multiple speakers (Vector Base Amplitude Panning: VBAP). FIG. 1 illustrates the concept of VBAP. Using amplitude panning, which determines the direction of a sound source between two speakers based on the signal amplitude, or using VBAP, which is widely used for determining the direction of a sound source by using three speakers in a 3-dimensional space, rendering may be conveniently implemented for the object signal, which is transmitted on an object basis.

In other words, a virtual speaker1 140 may be generated using three speakers 110, 120, and 130, as shown in FIG. 1. VBAP is a method for generating an object vector in which the virtual source will be located based on the position of a listener (sweet spot), and the method renders a sound source by selecting speakers around the listener and by calculating a gain value for controlling the speaker positioning vector. Therefore, for object-based content, at least three speakers surrounding the target object (or the virtual source) are determined and VBAP is reconfigured according to the relative positions of the speakers, whereby the object may be reproduced in a desired position.

### DISCLOSURE

### Technical Problem

In a 3-dimensional audio environment, there may be a situation in which sound arrives from under the user's feet, that is, the main event of content occurs at a position that is lower than the viewer's position.

Various effects can be obtained by localizing a sound source at a very low position. It may be very helpfully used in various situations or scenes, for example, in which a main character falls from a high place, a subway passes underground, or a huge explosion occurs, or in a honor scene in which an unknown monster passes underfoot. In other words, by localizing a sound source at a position lower than the installed speaker, a vivid sound field, which cannot be supported by existing audio systems, may be provided to a user in many dramatic scenes.

Typical VBAP technology is not capable of rendering in a space in which no speaker is located. In the case of the 22.2-channel system, which is a multi-channel system, speakers are arranged to cover the full range above a user's head, but under the user's feet, only 3 channels are present in the front. Namely, in the 22.2-channel speaker environment, a virtual source cannot be reproduced in the area lower than the user, excluding a portion of the front area, in which three bottom layer speakers are arranged. In other words, a renderer has the lowest elevation in which an object may be reproduced depending on the object angle. The lowest elevation for reproduction is determined by a line (speakermesh) connecting the speakers in the lowest position. For example, in the case of the 22.2-channel environment, a line connecting BtFC, BtFL, SiL, BL, BC, BR, SiR, and BtFR forms a speakermesh, and the elevation of the mesh indicates the lowest elevation enabling the reproduction. In other words, an elevation of 10° is applicable to an object (BtFL) of which the angle is 45°, but when the object has an elevation lower than BtFL, the elevation is automatically adjusted to the lowest elevation (10°), and then the object is reproduced. Simply put, under the current configuration, sound originating from under the user's feet cannot be reproduced.

The present invention relates to the generation of a virtual object with regard to a new technology issue, namely, rendering in the area out of a speakermesh. Here, the lower elevation may be an embodiment in which sound extrapolation is necessary to realize the most dramatic effects.

### Technical Solution

An audio signal processing method for reproducing an audio signal including an object signal according to an embodiment of the present invention includes: receiving an audio bit-stream including both object sound source information and an object audio signal; distinguishing a first reproduction range object from a second reproduction range object, based on the object sound source information or reproduction range information; and rendering the first reproduction range object by a first method, and rendering the second reproduction range object by a second method.

The audio signal processing method may further include: receiving speaker position information; and generating the reproduction range information using the speaker position information.

The first reproduction range object may include an object sound source signal, designed to be reproduced in an area falling out of a reproduction range, based on the received speaker position information and the object sound source position information.

The second reproduction range object may include an object sound source signal, designed to be reproduced in an area falling within a reproduction range, based on the received speaker position information and the object sound source position information.

The object sound source information may include object sound source position information or exceptional object indication information.

The exceptional object indication information may be additional information represented by one bit for each object.

The exceptional object indication information may include one or more bits of additional information contained in an object sound source header, the additional information being different according to a reproduction environment.

The first method generates a virtual speaker and may perform rendering by a method of panning between the virtual speaker and an actual speaker.

The first method may be a combination of a method for generating a low-pass filtered signal and a method for generating a band-pass filtered signal.

The first method generates a downmixed signal from a sound source signal of the first reproduction range object for the multiple object signals, and then may generate a low-pass filtered subwoofer signal using the downmixed signal.

The first method may generate a low-pass filtered signal for the object audio signal.

The second method may be a flexible rendering method for localizing the second reproduction range object at a position designated in the object sound source information.

The first method may include a filtering step for localizing the first reproduction range object at a position designated in the object sound source information.

The second method may be a flexible rendering method for localizing the second reproduction range object at a position designated in the object sound source information.

The first method may form a filter coefficient based on a human's psychoacoustic feature, using an object position (elevation, angle, distance) of object sound source position information, and using a relative position of a listener.

### Advantageous Effects

According to the present invention, a technique capable of locating an object signal in the position that was not considered is provided. When the technique is used to generate an object signal at the side/back position of a bottom layer, added value can be created. The technique may also be applied between a decoder and a renderer, and a high-quality audio signal can be reproduced by effectively reproducing audio signals.

### DESCRIPTION OF DRAWINGS

FIG. 1 is a view illustrating the concept of a general rendering method (VBAP) using multiple speakers;

FIG. 2 is a configuration diagram in which 22.2-channel speakers are arranged as an example of a multi-channel arrangement;

FIG. 3 is a view illustrating the input and output of a renderer to explain a rendering system;

FIG. 4 is a view illustrating an audio signal processing device according to an embodiment of the present invention;

FIG. 5 is a view simply illustrating the input and output of a virtual object generation unit for generating a subwoofer signal, according to an embodiment of the present invention;

FIG. 6 is a block diagram of a virtual object generation unit for generating a subwoofer signal according to an embodiment of the present invention;

FIG. 7 is another block diagram of a virtual object generation unit for generating a subwoofer signal according to an embodiment of the present invention;

FIG. 8 is a block diagram of an audio signal processing device according to another embodiment of the present invention; and

FIG. 9 is a flow diagram of an object sound source rendering technique according to an embodiment of the present invention.

### BEST MODE

The embodiment described in this specification is provided for allowing those skilled in the art to more clearly comprehend the present invention. The present invention is not limited to the embodiment described in this specification, and the scope of the present invention should be construed as including various equivalents and modifications that can replace the embodiments and the configurations at the time at which the present application is filed.

Terms in this specification and the accompanying drawings are for easily describing the present invention, and the shape and size of the elements shown in the drawings may be exaggeratedly drawn. The present invention is not limited to the terms used in this specification and the accompanying drawings.

In the following description, when the functions of conventional elements and the detailed description of elements related with the present invention may make the gist of the present invention unclear, a detailed description of those elements will be omitted.

In the present invention, the following terms may be construed based on the following criteria, and terms which are not used herein may also be construed based on the following criteria. The term “coding” may be construed as encoding or decoding and the term “information” includes values, parameters, coefficients, elements, etc. and the meanings thereof may be differently construed according to the circumstances, and the present invention is not limited thereto.

Hereinafter, an object audio signal processing device and method according to an embodiment of the present invention are described.

The present invention relates to a technique for locating an object signal in the area out of the speaker range (speakermesh) to reproduce an object sound source using a limited number of speakers, fixed in prescribed positions.

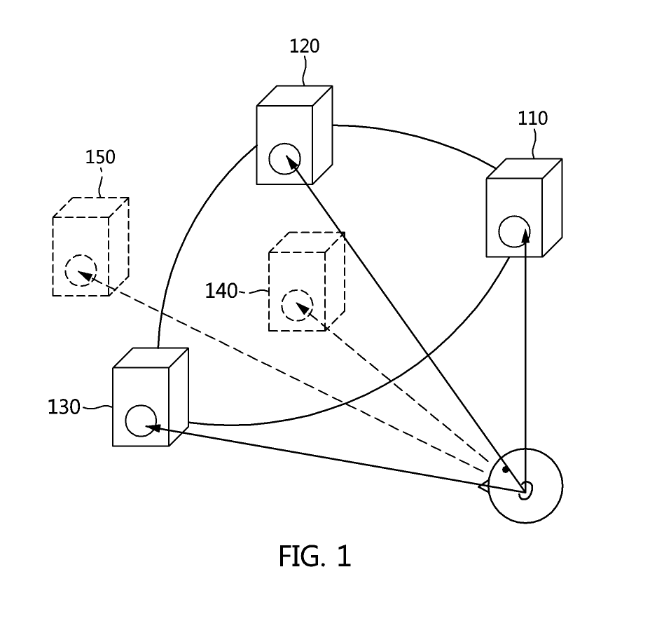

FIG. 1 is a view illustrating the concept of a general rendering method (VBAP) using multiple speakers.

As illustrated in FIG. 1, existing techniques (for example, VBAP) may generate a virtual speaker1 140 using three speakers 110, 120, and 130, which actually output a channel signal, but have a problem in generating a virtual speaker2 150.

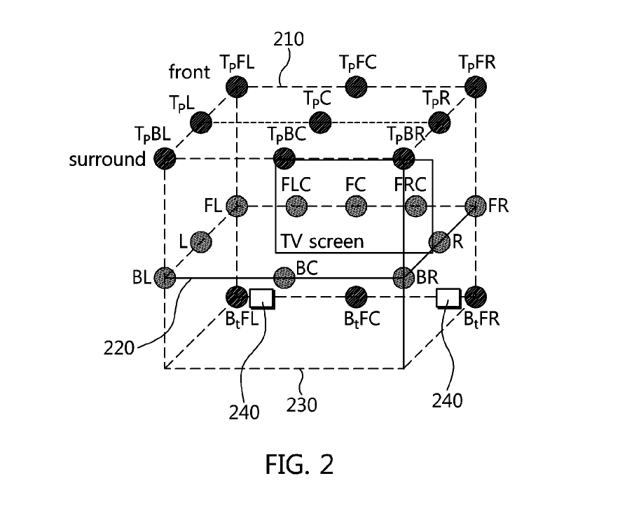

Next, referring to FIG. 2, the 22.2-channel speaker placement is described as an example of a multi-channel arrangement.

FIG. 2 is a configuration diagram for a 22.2-channel speaker arrangement as an example of a multi-channel arrangement.

Hereinafter, the 22.2-channel speaker arrangement is described with reference to an example. However, the present invention is not limited to the example. Namely, the present invention may be applied to speakers arranged differently from FIG. 2, or applied to a number of speakers different from FIG. 2.

The 22.2-channel arrangement may be one example of a multi-channel environment for improving sound staging, but the present invention is not limited to a specific number of channels or specific speaker arrangement. Referring to FIG. 2, the 22.2-channel is arranged by being distributed to three layers 210, 220, and 230. The three layers 210, 220, and 230 include a top layer 210 in the highest position among the three layers, a bottom layer 230 in the lowest position, and a middle layer 220 between the top layer 210 and the bottom layer 230.

According to an embodiment of the present invention, a total of 9 channels, namely TpFL, TpFC, TpFR, TpL, TpC, TpR, TpBL, TpBC, and TpBR, may be provided in the top layer 210. Referring to FIG. 2, it is confirmed that speakers are disposed in the 9 channels of the top layer 210 in such a way that there are 3 channels TpFL, TpFC, and TpFR arranged from left to right at the front, 3 channels TpL, TpC, and TpR arranged from left to right at the center position, and 3 channels TpBL, TpBC, and TpBR arranged from left to right at the back position. In this specification, the front side may mean the screen side.

According to an embodiment of the present invention, a total of 10 channels, namely FL, FLC, FC, FRC, FR, L, R, BL, BC, and BL, may be provided in the middle layer 220. Referring to FIG. 2, speakers may be disposed at the 5 channels, that is, FL, FLC, FC, FRC, and FR, arranged from left to right at the front, in the 2 channels, L and R, arranged at left and right at the center position, and in the 3 channels, BL, BC, and BL, arranged from left to right at the back position. Among the 5 speakers at the front, the 3 speakers at the center position may be included in a TV screen.

According to an embodiment of the present invention, in the bottom layer 230, a total of 3 channels, BtFL, BtFC, and BtFR, may be provided at the front, and 2 LFE channels 240 may also be provided. Referring to FIG. 2, speakers may be disposed at each of the channels in the bottom layer 230.

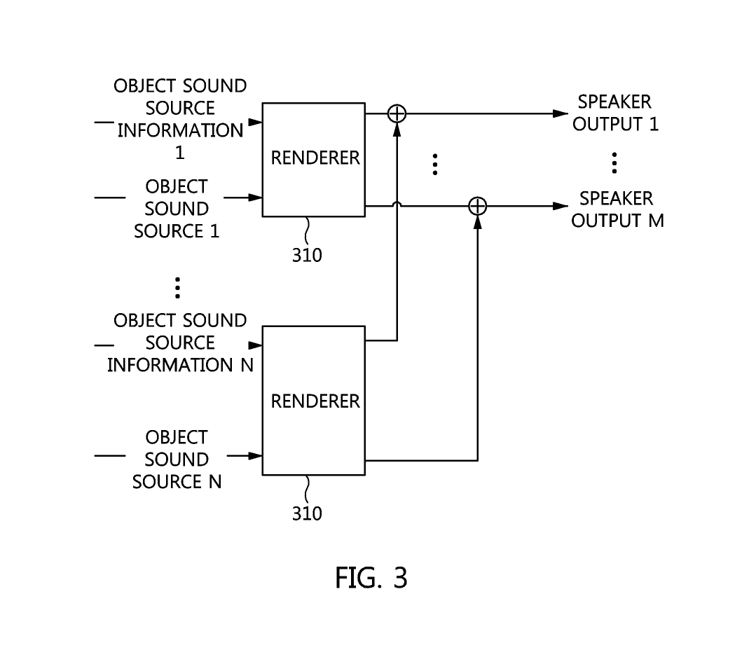

FIG. 3 is a view illustrating the input and output of a renderer for explaining a rendering system.

Referring to FIG. 3, each object sound source, input to an audio signal processing device, is rendered by a renderer 310, using its object sound source information. Then, the rendered object signals are combined to make a speaker output (that is, a channel signal). Also, the audio signal processing device according to an embodiment of the present invention may be a sound rendering system.

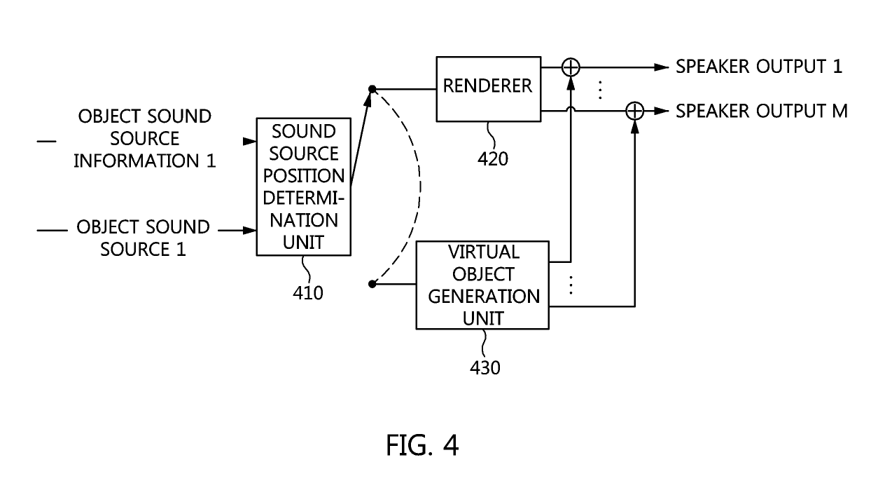

FIG. 4 is a view illustrating an audio signal processing device according to an embodiment of the present invention.

The audio signal processing device according to an embodiment of the present invention includes a sound source position determination unit 410 for determining the position of the input object sound source and a virtual object generation unit 430 for locating the object signal in an area out of the speaker range. Also, the audio signal processing device according to an embodiment of the present invention includes a renderer 420. The renderer 420 according to an embodiment of the present invention may be the same as the renderer 310 described in FIG. 3. Also, the renderer 420 performs rendering according to a conventional method. Namely, the renderer 420 performs rendering by a general method.

An object that has been determined to fall outside of the speaker range by the sound source position determination unit 410 is rendered by the virtual object generation unit 430, and other objects determined not to fall outside of the speaker range (that is, objects that may be covered by the speaker range) are rendered by the renderer 420.

In FIG. 4 according to an embodiment of the present invention, a structure corresponding to a renderer 420 for one object sound source is illustrated in detail, and the whole structure of the present invention is formed by the combination of the structures illustrated in FIG. 4.

The audio signal processing device according to an embodiment of the present invention further includes a sound source position determination unit 410 and a virtual object generation unit 430, in addition to the renderer 310 of FIG. 3. Namely, the audio signal processing device according to the embodiment of the present invention includes a sound source position determination unit 410, a renderer 420, and a virtual object generation unit 430.

The sound source position determination unit 410 assigns an object sound source to either the renderer 420 or the virtual object generation unit 430, based on the object sound source information.

The assigned object sound source is rendered by the renderer 420 or by the virtual object generation unit 430, and generates a speaker output.

The sound source position determination unit 410 according to an embodiment of the present invention is described below.

<Sound Source Position Determination Unit>

The sound source position determination unit 410 distinguishes an object intended to be located in the area out of the speaker range using the header information of the object sound source. In this specification, the speaker range may be the range in which a sound source can be reproduced.

To determine the position of the sound source, it is necessary to set the range in which the sound source can be reproduced.

The range for reproduction is a virtual range that connects speakers required for localizing the object sound source. Generally, the range for reproduction may be formed by a line connecting respective speakers, based on VBAP, which is a method for selecting three speakers capable of forming the smallest triangle including the position where the sound source will be located.

Therefore, the maximum range for reproduction may be the speaker arrangement that enables closely localizing the sound source at all positions around the user, but the general range for reproduction may be a limited range covering fewer positions. For example, in the case of the 5.1-channel speaker setup, the range for reproduction becomes a 360° plane from side to side at the height of the user's ear level. In this case, because the positions of the installed speakers may not correspond to the installation regulation, the user may directly input the speaker position information (using a UI), or may input the information by selecting one from among a given set. Also, the information may be input by using a distant location confirmation technique.

The sound source position determination unit 410 determines whether the position at which the corresponding object sound source (object) is localized falls outside of the range for the reproduction or within the range for the reproduction by comparing the object sound source position information with the range for reproduction. In this case, an object sound source to be localized at a position out of the range for reproduction is rendered by the virtual object generation unit 430, and other objects (namely, object sound sources that can be reproduced by the combination of the speakers) are rendered by the existing technique. In other words, an object sound source to be localized at a position that is not out of the range for reproduction is rendered by the renderer 420.

Besides the above-mentioned method, which enables the sound source position determination unit 410 to distinguish an object that falls outside of the range using the object information transmitted with the object, there is a method in which a content producer adds a flag as additional information about the object to be located in the area out of the speaker range in the standard setup.

The flag may be a single bit of information that simply indicates that the corresponding object is an exception. More complexly, using a few bits of information, the method may include additional information that is necessary for vividly reproducing the corresponding object (for example, the method may add additional information to reproduce the object differently depending on whether the speaker arrangement corresponds to a standard setup or to a specific setup).

The flag indicating the exceptional object may be set by a content producer when the sound source is generated. Namely, when audio content is produced, the producer who intends to localize a specific object sound source at a position that is not covered by a general speaker setup environment (for example, under the user's feet) may form object sound source information in which the flag of the object is set to an ON state. In this case, the content may be produced in various steps, such as a mastering step, a releasing step, and a targeting step. Accordingly, although the flag has been set, the flag may be changed or expanded many times while passing through the production steps. Furthermore, the flag, which is included in the additional information about the object, may be formed by different information depending on the user's environment.

Also, in the process of determination, a speaker range (speakermesh) may be frequently reconfigured to be adapted to the user environment, depending on the change in the current user's speaker arrangement. Generally, the speaker range (or the range in which a sound source can be reproduced) is initialized to be adapted to the arrangement of a screen and a speaker in the installation environment, and the initialized rendering matrix may be continuously available without modification unless there is a change in the installation environment. However, if the user generates a specific trigger, or arbitrarily intends to perform a calibration process, the initialized range for reproduction may be modified. In this case, the position of the installed devices may be directly input by the user (using a UI device), or may be measured using various methods (for example, automatic location detection using communication between devices.)

<Virtual Object Generation Unit>

The virtual object generation unit 430 may provide various methods to effectively render an object that should be localized at a position outside of the reproduction range. The virtual object generation unit 430 according to an embodiment of the present invention may provide various virtual object generation methods for effectively rendering an object that should be localized at a position outside of the reproduction range.

As an embodiment of the virtual object generation method, there is a method for performing a filtering process to localize a corresponding object at a target position. Considering the position (elevation, angle, and distance) of the corresponding object and the position of a listener, a filter coefficient is formed based on psychoacoustic features. Here, the method may be performed by removing a frequency cue corresponding to the position of the speaker itself from a signal to be output from a specific speaker, and intentionally inserting a frequency cue corresponding to the position of the object sound source.

Specifically, it is confirmed that an elevation spectral cue, which is a cue to enable a person to recognize sound source elevation, is present in the frequency domain, by analyzing a Head-Related Transfer Function (HRTF), which is obtained from sound sources located at different elevations. In HRTF, depending on the elevation, a notch is generated in a certain high frequency band because of the shape of the listener's pinnae. Therefore, in this specific frequency band, the virtual source can be reproduced at a desired elevation. Furthermore, reflections from the listener's torso cause a change in the frequency spectrum. Accordingly, the filtering structure is formed in consideration of the spectrum change by the pinnae and torso.

This is accomplished by removing a frequency cue corresponding to the position of the speaker itself from a signal to be output from a specific speaker, and intentionally inserting a frequency cue corresponding to the position of a virtual source. For example, suppose that a BtFL speaker (angle 45°, elevation 10°) is used to generate a virtual source of which the angle is 45° and the elevation is 50°. Preprocessing is performed not to generate an elevation spectral cue corresponding to the speaker position (angle 45°, elevation 10°) in the signal input to BtFL, and an elevation spectral cue indicating the virtual source position (angle 45°, elevation 50°) is inserted. As a result, the sound image corresponding to the elevation of the virtual source is reproduced.

Furthermore, the virtual object generation technique based on filtering, according to an embodiment of the present invention, may be a technique for providing a modified filter to minimize the disadvantage of distortion, generated in the signal by the filter. First, a slight difference is made in the null position of the filter applied to each speaker, whereby a listener may not hear the distortion of the signal. Depending on the individual involved, an elevation cue has a different null position. However, for generalization, null may be formed in a relatively wide frequency band. Accordingly, different speakers share the generation of elevation cues within the generalized null frequency range. In this case, filtering may be applied to the divided bands, or a group to which filtering is applied may be separated from a group to which simple VBAP is applied, whereby the listener may be prevented from hearing the distortion of the signal.

Also, a virtual object generation method of the virtual object generation unit 430 according to another embodiment of the present invention may be implemented by a panning method whereby a virtual speaker is generated to reproduce an object signal outside of the range within which the object can be reproduced by speakers, and the virtual speaker and actual speakers are used together.

When an object that falls outside of the range within which an object can be reproduced by speakers generates a virtual speaker by panning, the virtual object generation unit 430 may implement a method for mapping the virtual speaker to the position of an actual speaker. In this case, the mapping is implemented by a predefined rule, and during this process, the above-mentioned filtering may be used.

Also, the virtual object generation method of the virtual object generation unit 430 according to an embodiment of the present invention may be a virtual object generation technique that uses a subwoofer signal generation method to reproduce an object signal that is out of the range within which the reproduction may be performed by speakers. In the case of the existing 5.1-, 10.1-, or 22.2-channel signal, a low frequency effect (LFE) channel signal, corresponding to 0.1 or 0.2, delivers only low frequency information (less than 120 Hz), and has the purpose of supplementing the overall low frequency content of an audio scene or lightening the burden on other channels.

Again, referring to FIG. 2, generally, the LFE channel 240 of FIG. 2 is not the same as a subwoofer signal. Also, the encoding technique according to an embodiment of the present invention may not provide a subwoofer output during the encoding process, and may generate a subwoofer output to compensate for the limitation of a main speaker, which may not completely reproduce low-frequency information when audio content that does not include a LFE channel 240 is reproduced.

The present invention includes a method for generating a subwoofer signal to reproduce an object signal outside of the range for reproduction (for example, under the user's feet).

Generally, it is known that a subwoofer output does not directly affect the sensing directionality in a sound track, but in a special case, such as under the user's feet, in which human's direction recognition ability is low, the reality of a sound field may be enhanced by simply adjusting the level of the subwoofer output. Furthermore, because it is difficult to localize a sound source at a position at which no speaker is located with the existing technique based on VBAP, the reproduction of a virtual sound source using a subwoofer output is helpful for a user to recognize a spatial object sound source with sound staging.

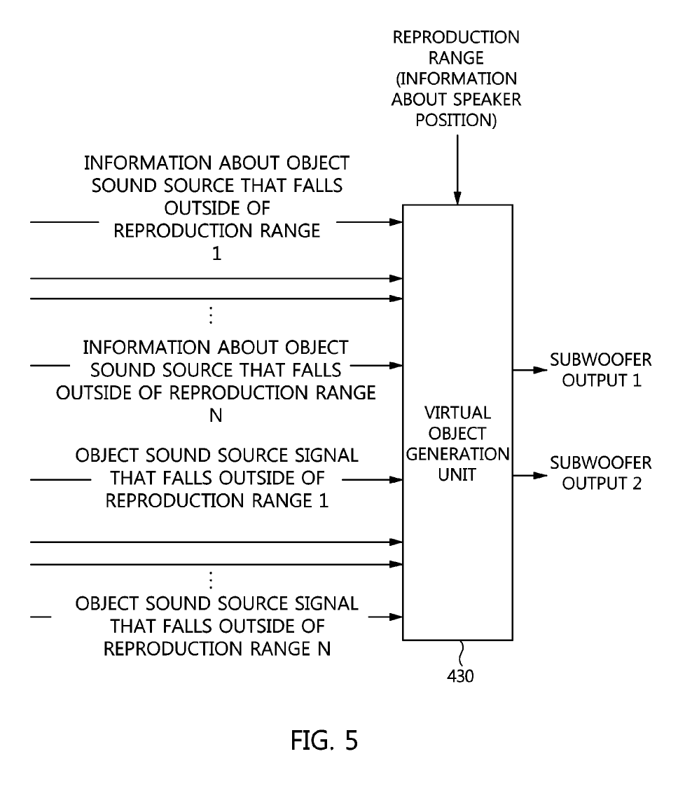

FIG. 5 is a view simply illustrating the input and output of the virtual object generation unit for generating a subwoofer signal, according to an embodiment of the present invention.

The virtual object generation unit 430 according to the present invention receives a range for reproduction, which is calculated based on speaker position information, an object sound source signal determined to fall outside of the reproduction range, and the sound source information of the corresponding object as inputs, and then outputs a subwoofer output signal.

Here, the subwoofer output signal may be a signal assigned to one or more subwoofers according to the speaker setup of a user environment. When one or more object sound source signals are reproduced, the virtual object generation unit 430 generates the final output signal by the linear addition of subwoofer output signals that are generated from the individual object sound source signals.

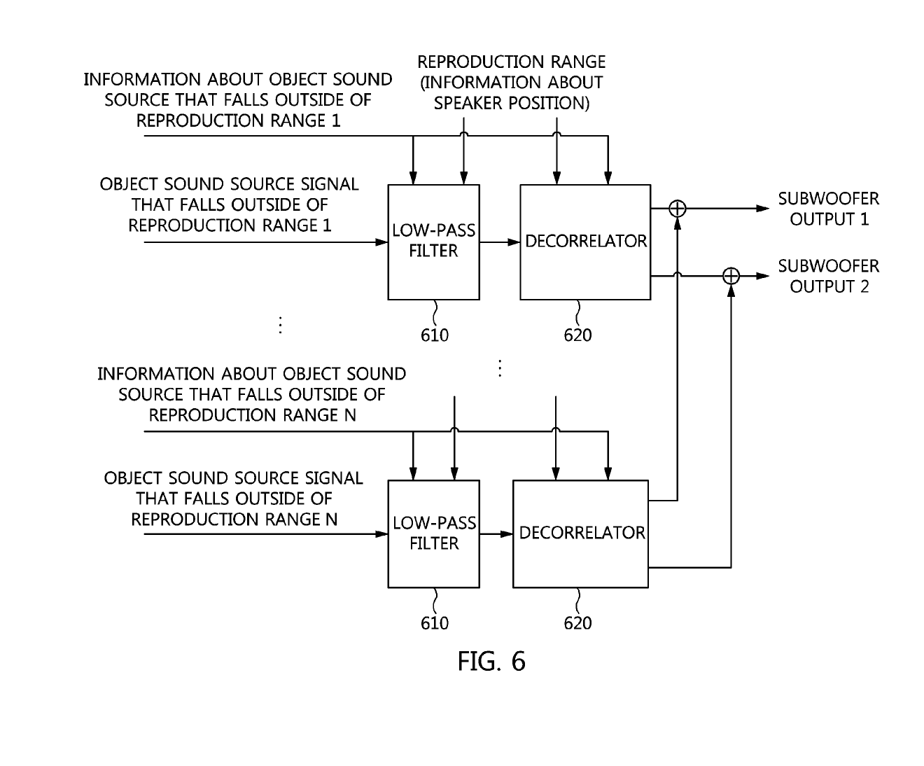

FIG. 6 is a block diagram of a virtual object generation unit using the subwoofer signal generation method.

The virtual object generation unit 430 of FIG. 6 corresponds to one example of the virtual object generation unit 430 of FIG. 5. The virtual object generation unit 430 of FIG. 6 represents a system that receives an object sound signal that has been determined to fall outside of the reproduction range, along with sound source information of the corresponding object, and outputs a subwoofer output signal.

To this end, the low-pass filter 610 of the virtual object generation unit 430 extracts a low frequency signal of the corresponding object sound source through low-pass filtering (LPF). A decorrelator 620 generates two subwoofer output signals based on the extracted low frequency signal.

In this case, because the virtual object generation unit 430 determines decorrelator coefficients and the cutoff frequency for the low-pass filtering, using a reproduction range calculated based on the speaker position information and using the position information of the corresponding object sound source, different filtering is applied according to the object. The determined decorrelator coefficients serve to assign gain and a delay value, which are required for localizing a corresponding object sound source at a target position, to a final subwoofer output.

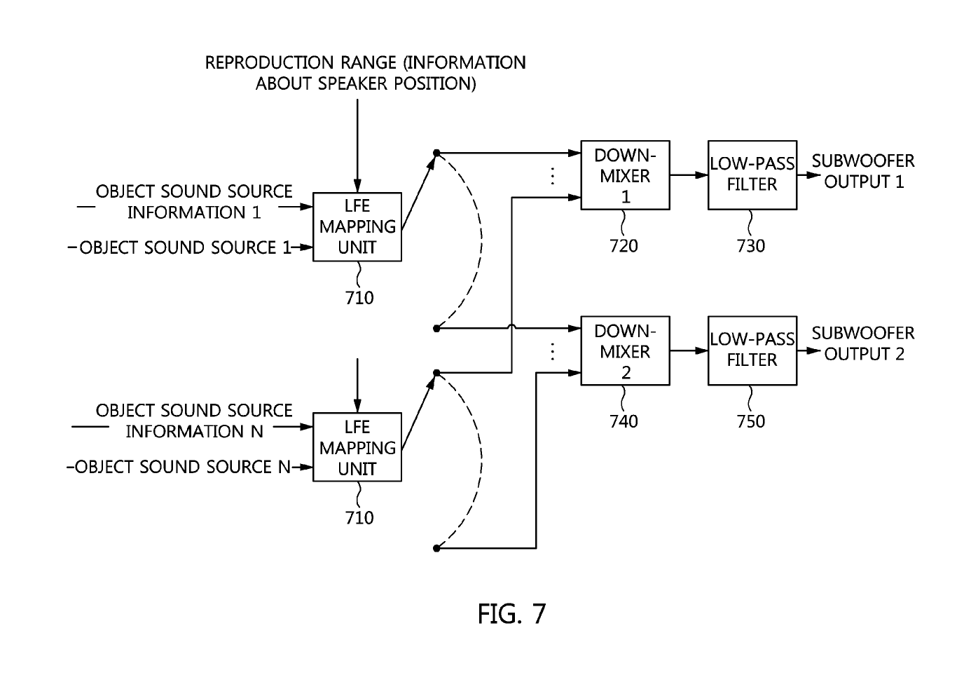

FIG. 7 is another block diagram of a virtual object generation unit for generating a subwoofer signal, according to an embodiment of the present invention.

FIG. 7 corresponds to one example of the virtual object generation unit 430 of FIG. 5, and represents a system that receives an object sound source signal determined to fall outside of the reproduction range together with the sound source information of the corresponding object, and then outputs a subwoofer output signal.

To this end, the virtual object generation unit 430 selects either a downmixer1 720 or a downmixer2 740 using an LFE mapping unit 710. The LFE mapping unit 710 may select either the downmixer1 720 or the downmixer2 740 based on LFE mapping. In this case, the LFE mapping unit 710 selects an appropriate downmixer using the range for reproduction, calculated based on the position information of a speaker, and using the position information of the corresponding object sound source. When the LFE mapping unit 710 has selected a downmixer appropriate to each input object signal, the downmixer 720 or 740 downmixes the input object signals. Low-pass filters 730 and 750 generate two LFE channel signals by extracting a low frequency signal of the corresponding object sound source through low-pass filtering. The virtual object generation unit 430 according to an embodiment of the present invention requires only as many downmixers as there are subwoofers, in addition to low-pass filtering, thus having an advantage in terms of complexity.

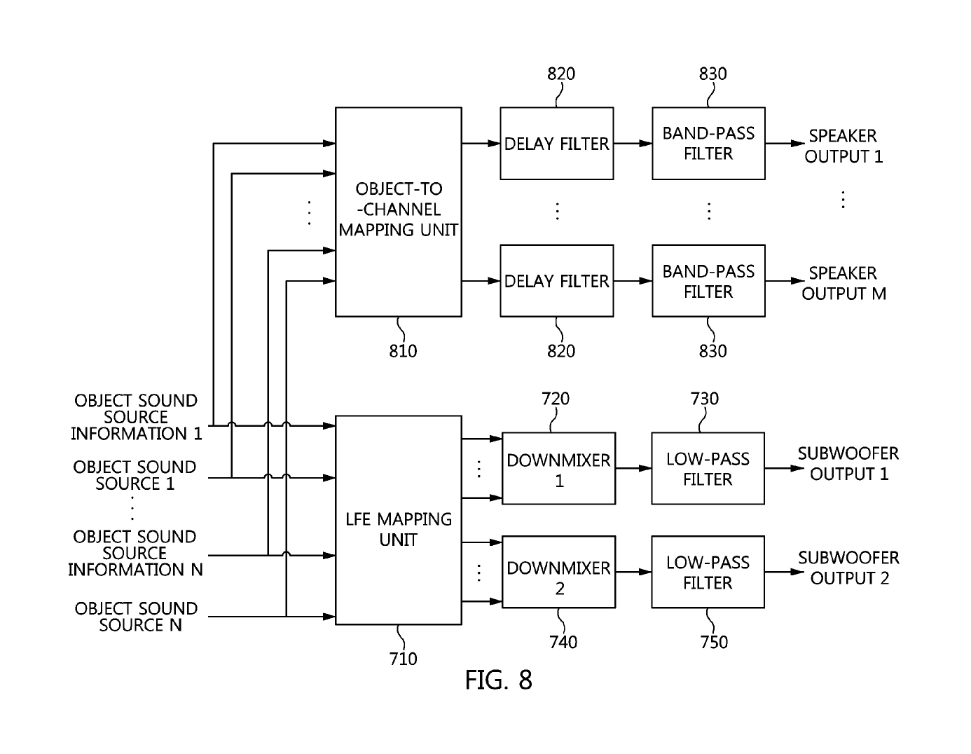

FIG. 8 is a block diagram of an audio signal processing device according to another embodiment of the present invention.

The audio signal processing device of FIG. 8 further includes an object-to-channel mapping unit 810, delay filters 820 and 840, and band-pass filters 830 and 850, in addition to the virtual object generation unit 430 of FIG. 7. However, the present invention is not limited to the above configuration. In other words, the present invention may be applied to the case in which the object-to-channel mapping unit 810, the delay filters 820 and 840, and the band-pass filters 830 and 850 are further included, in addition to the virtual object generation unit 430 of FIG. 5 or FIG. 6.

The audio signal processing device of FIG. 8 not only reproduces a sound field for a sound source at a low position through the method for generating a subwoofer signal using a low-pass filter of FIGS. 5, 6, and 7 but also reproduces a sound field for a sound source at a low position through a method for generating a speaker output signal using band-pass filters 830 and 850.

A low frequency signal provides the overall sound staging of a sound source located at a low position by being output through a subwoofer, and the object sound source in an intermediate frequency band is output through a speaker, whereby correct sound localization may be achieved. In this case, the localization of the object sound source in the intermediate frequency band is implemented by a method whereby a delay value corresponding to the position at which the sound source will be localized is assigned using a Haas effect. The key to this technique is that the localization of a sound source may be optimized by outputting an additional signal of the intermediate frequency band, in addition to the output signal of a subwoofer.

To this end, the object-to-channel mapping unit 810 selects one or more necessary speaker channels, using object sound source information, and assigns the object sound source to the speaker channels. The object signal assigned to the speaker channel passes through the delay filter 820 and 840, and is delayed enough to realize the Hass effect. Then, the band-pass filter 830 and 850 receives the signal, which has passed through the delay filter 820 and 840, and generates a speaker channel output by passing the intermediate frequency band of the object signal.

In the present invention, the sequence in which the delay filters 820 and 840 and the band-pass filters 830 and 850 are applied may be changed according to need. Namely, the object signal assigned to the channel may pass the band-pass filters 830 and 850, and may then be delayed by the delay filters 820 and 840 according to the circumstances for the purpose of reducing complexity or increasing convenience of implementation.

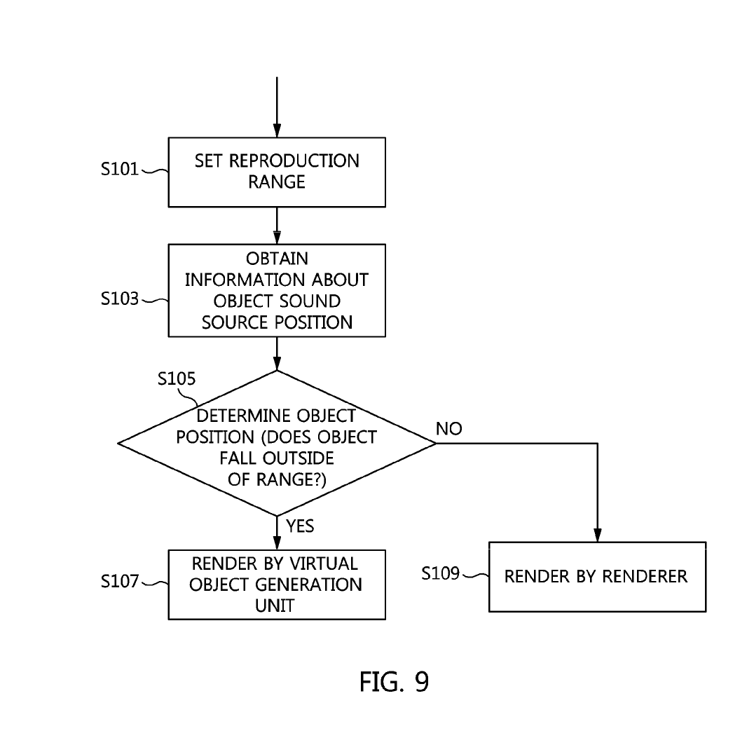

On the other hand, the method for generating a subwoofer output is not limited to the example illustrated in the lower side of FIG. 9, and the other methods described above may be used according to the user environment, the intention of the user and the content producer, or the properties of an object signal.

<Overall Flowchart>

FIG. 9 illustrates a flowchart of the object sound source rendering technique of the present invention.

The sound source rendering technique according to an embodiment of the present invention relates to a method for calculating a range for reproduction using speaker position information, and because the positions of the installed speakers may not correspond to installation guidelines, a user may directly input the speaker position information (using a UI), or may input the information by selecting one from among a given set, or by using a distant location confirmation technique. Generally, the range for reproduction may be formed by a line connecting speakers based on VBAP, which is a method for selecting three speakers capable of forming the smallest triangle that contains the position at which the sound source is intended to be localized.

Therefore, the maximum range for reproduction may be the speaker arrangement capable of closely localizing the sound source at all positions around the user, but the general range for reproduction may be a limited range covering fewer positions. (For example, in the case of the 5.1-channel speaker setup, the range for reproduction becomes a 360° plane from side to side at the height of the user's ear level.)

After forming the range for reproduction based on the speaker arrangement information, the sound source position determination unit 410 acquires the position information of the object sound source and the object sound source signal from the sound source bit-stream at step S103. Also, the sound source position determination unit 410 compares the object sound source position information with the range for reproduction, and determines whether the corresponding object sound source should be localized at a position that falls outside of the range for reproduction at step S105. In this case, the object sound source that should be localized at a position that falls outside of the range for reproduction is rendered by the virtual object generation unit 430 at step S107, and other objects that fall sound sources that fall within the range for the reproduction are rendered by the existing renderer 420.

The audio signal processing method according to the present invention may be implemented as a program that can be executed by various computer means. In this case, the program may be recorded on a computer-readable storage medium. Also, multimedia data having a data structure according to the present invention may be recorded on the computer-readable storage medium. The computer-readable storage medium may include all types of storage media to record data readable by a computer system. Examples of the computer-readable storage medium include the following: ROM, RAM, CD-ROM, magnetic tapes, floppy disks, optical data storage, and the like. Also, the computer-readable storage medium may be implemented in the form of carrier waves (for example, transmission over the Internet). Also, the bit-stream generated by the above-described encoding method may be recorded on the computer-readable storage medium, or may be transmitted using a wired/wireless communication network.

Meanwhile, the present invention is not limited to the above-described embodiments, and may be changed and modified without departing from the gist of the present invention, and it should be understood that the technical spirit of such changes and modifications also belong to the scope of the accompanying claims.

1. An audio signal processing method for reproducing an audio signal including an object signal, comprising:
receiving an audio bit-stream including both object sound source information and an object audio signal;
distinguishing a first reproduction range object from a second reproduction range object, based on the object sound source information or reproduction range information; and
rendering the first reproduction range object by a first method, and rendering the second reproduction range object by a second method.

2. The audio signal processing method for reproducing an audio signal including an object signal according to claim 1, further comprising:
receiving speaker position information; and
generating the reproduction range information using the speaker position information.

3. The audio signal processing method for reproducing an audio signal including an object signal according to claim 2, wherein the first reproduction range object includes an object sound source signal, designed to be reproduced in an area falling out of a reproduction range, based on the received speaker position information and object sound source position information.

4. The audio signal processing method for reproducing an audio signal including an object signal according to claim 2, wherein the second reproduction range object includes an object sound source signal, designed to be reproduced in an area falling within a reproduction range, based on the received speaker position information and object sound source position information.

5. The audio signal processing method for reproducing an audio signal including an object signal according to claim 1, wherein the object sound source information includes object sound source position information or exceptional object indication information.

6. The audio signal processing method for reproducing an audio signal including an object signal according to claim 5, wherein the exceptional object indication information is additional information represented by one bit for each object.

7. The audio signal processing method for reproducing an audio signal including an object signal according to claim 5, wherein the exceptional object indication information includes one or more bits of additional information contained in an object sound source header, the additional information being different according to a reproduction environment.

8. The audio signal processing method for reproducing an audio signal including an object signal according to claim 1, wherein the first method generates a virtual speaker and performs rendering by a method of panning between the virtual speaker and an actual speaker.

9. The audio signal processing method for reproducing an audio signal including an object signal according to claim 1, wherein the first method is a combination of a method for generating a low-pass filtered signal and a method for generating a band-pass filtered signal.

10. The audio signal processing method for reproducing an audio signal including an object signal according to claim 1, wherein the first method generates a downmixed signal from a sound source signal of the first reproduction range object for the multiple object signals, and then generates a low-pass filtered subwoofer signal using the downmixed signal.

11. The audio signal processing method for reproducing an audio signal including an object signal according to claim 1, wherein the first method generates a low-pass filtered signal for the object audio signal.

12. The audio signal processing method for reproducing an audio signal including an object signal according to claim 1, wherein the second method is a flexible rendering method for localizing the second reproduction range object at a position designated in the object sound source information.

13. The audio signal processing method for reproducing an audio signal including an object signal according to claim 1, wherein the first method includes a filtering step for localizing the first reproduction range object at a position designated in the object sound source information.

14. (canceled)

15. The audio signal processing method for reproducing an audio signal including an object signal according to claim 1, wherein the first method forms a filter coefficient based on a human's psychoacoustic feature, using an object position (elevation, angle, distance) of object sound source position information, and using a relative position of a listener.
